(19) United States
(12) Patent Application Publication
(10) Pub. No.: US 2024/0274801 A1
(43) Pub. Date: Aug. 15, 2024

(54) ELECTROCHEMICAL DEVICE AND ELECTRONIC DEVICE

(71) Applicant: Ningde Amperex Technology Limited, Ningde (CN)

(72) Inventors: Bing JIANG, Ningde (CN); Tao LIU, Ningde (CN); Feng ZHOU, Ningde (CN); Qingwen ZHANG, Ningde (CN)

(73) Assignee: Ningde Amperex Technology Limited, Ningde (CN)

(21) Appl. No.: 18/436,115

(22) Filed: Feb. 8, 2024

Related U.S. Application Data
(63) Continuation of application No. PCT/CN2021/111736, filed on Aug. 10, 2021.

(51) Int. Cl. H01M 4/36; H01M 4/02; H01M 4/139; H01M 10/0525; H01M 50/536

(52) U.S. Cl. CPC H01M 4/366; H01M 4/139; H01M 10/0525; H01M 50/536; H01M 2004/021

(57) ABSTRACT

An electrochemical device includes a first electrode plate, a second electrode plate, and a separator disposed between the first electrode plate and the second electrode plate. The first electrode plate includes a current collector, a tab, and an active layer. The tab is electrically connected to and extends out of the current collector. The active layer is disposed on a surface of the current collector. The active layer includes a first active layer and a second active layer. In a first direction, the first active layer is located on a side of the second active layer facing the tab, and is adjacent to or partially overlaps the second active layer. In a second direction, the first active layer and the second active layer extend in a strip shape. The cohesive force of the first active layer is greater than the cohesive force of the second active layer.

### CROSS-REFERENCE TO RELATED APPLICATION

This application is a continuation of International Patent Application No. PCT/CN2021/111736, filed on Aug. 10, 2021, the disclosure of which is hereby incorporated by reference in its entirety.

### TECHNICAL FIELD

This application relates to the field of electrochemical energy storage, and in particular, to an electrochemical device and an electronic device.

### BACKGROUND

The volumetric energy density of electrochemical devices (for example, lithium-ion batteries) has always been a bottleneck restricting the development of the electrochemical devices. In order to increase the volumetric energy density of the electrochemical devices, it is usually necessary to increase the compaction density of an electrode plate. However, under the condition of increasing the compaction density of the electrode plate, due to the high pressure, an active material layer at the edge of the electrode plate is prone to loosening and powder falling, which is not conducive to the increase of the energy density of the electrode plate and may cause a risk of lithium precipitation. Therefore, further improvements are desired.

### SUMMARY

Some embodiments of this application provide an electrochemical device. The electrochemical device includes a first electrode plate, a second electrode plate electrically different from the first electrode plate, and a separator disposed between the first electrode plate and the second electrode plate. The first electrode plate includes a current collector, a tab and an active layer, and the tab is electrically connected to and extends out of the current collector. The active layer is disposed on a surface of the current collector, and the active layer includes a first active layer and a second active layer. In a first direction, the first active layer is located on a side of the second active layer facing the tab, and is adjacent to or partially overlaps the second active layer. In a second direction, the first active layer and the second active layer extend in a strip shape. A cohesive force of the first active layer is greater than a cohesive force of the second active layer. In a three-dimensional rectangular coordinate system, the first direction is a direction in which the tab extends out of the current collector, a third direction is a thickness direction of a negative electrode plate, and the second direction is perpendicular to a plane on which the first direction and the second direction lie.

In this application, by making the cohesive force of the first active layer greater than the cohesive force of the second active layer, it is less likely for powder to fall at the edge of the electrode plate, so as to allow the compaction density of the electrode plate to be further increased, thereby increasing the volumetric energy density of the electrochemical device and reducing the risk of lithium precipitation.

In some embodiments, the cohesive force of the first active layer is 10 N/m to 20 N/m, and the cohesive force of the second active layer is 4 N/m to 8 N/m. Within this range, the phenomenon of powder falling at the edge of the electrode plate can be significantly improved, and will not adversely affect the conductivity of the electrode plate and the energy density of the electrochemical device.

In some embodiments, a width of the first active layer is 5 mm to 20 mm, and a width of the second active layer is 10 mm to 300 mm.

In some embodiments, a bonding force between the first active layer and the current collector is greater than a bonding force between the second active layer and the current collector. In this way, the active layer on the edge of the electrode plate has better adhesion with the current collector, and is less likely to fall off from the current collector.

In some embodiments, a bonding force between the first active layer and the current collector is 8 N/m to 20 N/m, and a bonding force between the second active layer and the current collector is 1 N/m to 8 N/m.

In some embodiments, the first active layer includes a first active material and a first adhesive, the second active layer includes a second active material and a second adhesive, and a powder compaction density of the first active material is greater than a powder compaction density of the second active material. By increasing the powder compaction density of the first active material at the edge of the electrode plate, the coating weight per unit area can be increased, which not only improves the phenomenon of powder falling at the edge of the electrode plate, but also increases the energy density of the electrochemical device.

In some embodiments, the first active layer includes a first active material and a first adhesive, the second active layer includes a second active material and a second adhesive, a mass fraction of the first adhesive in the first active layer is greater than a mass fraction of the second adhesive in the second active layer. A high adhesive content can increase adhesion between active material particles, and improve the phenomenon of powder falling at the edge of the electrode plate.

In some embodiments, the first active layer includes a first active material and a first adhesive, the second active layer includes a second active material and a second adhesive, a powder compaction density of the first active material is greater than a powder compaction density of the second active material, and a mass fraction of the first adhesive in the first active layer is greater than a mass fraction of the second adhesive in the second active layer. An increase of the powder compaction density of the active material and adhesive content in the first active layer further improves the phenomenon of powder falling at the edge of the electrode plate.

In some embodiments, the powder compaction density of the first active material is 1.8 g/cm³ to 2.5 g/cm³, and the powder compaction density of the second active material is 1 g/cm³ to 1.7 g/cm³.

In some embodiments, the mass fraction of the first adhesive in the first active layer is 15% to 30%, and the mass fraction of the second adhesive in the second active layer is 1% to 10%.

In some embodiments, the powder compaction density of the first active material is 1.8 g/cm³ to 2.5 g/cm³, the powder compaction density of the second active material is 1 g/cm³ to 1.7 g/cm³, the mass fraction of the first adhesive in the first active layer is 15% to 30%, and the mass fraction of the second adhesive in the second active layer is 1% to 10%.

In some embodiments, the first active material and the second active material each independently include at least one of natural graphite, artificial graphite, mesophase microcarbon sphere, hard carbon, soft carbon, silicon, silicon-carbon composite, silicon oxide, Li—Sn alloy, Li—Sn—O alloy, Sn, SnO, SnO₂, lithium titanate, Li—Al alloy or metallic lithium.

In some embodiments, the first adhesive and the second adhesive each independently include at least one of polypropylene alcohol, polyacrylic acid, polyacrylate, polyimide, polyamide-imide, styrene-butadiene rubber, polyvinylidene fluoride, polyvinylidene difluoride, polytetrafluoroethylene, polyvinyl butyral, water-based acrylic resin or carboxymethyl cellulose salt.

In some embodiments, the tab and the current collector are integrally formed.

Embodiments of this application further provide an electronic device. The electronic device includes the electrochemical device described above.

According to the embodiments of this application, by making the cohesive force of the first active layer greater than the cohesive force of the second active layer, it is less likely for powder to fall at the edge of the electrode plate, so as to allow the compaction density of the electrode plate to be further increased, thereby increasing the volumetric energy density of the electrochemical device and reducing the risk of lithium precipitation.

### BRIEF DESCRIPTION OF DRAWINGS

FIG. 1 shows a top view of a first electrode plate according to some embodiments of this application.

FIG. 2 shows a cross-sectional view of the first electrode plate shown in FIG. 1 along a direction AA′.

### DETAILED DESCRIPTION

The following embodiments will enable those skilled in the art to more fully understand this application, but do not limit the present application in any way.

Some embodiments of this application provide an electrochemical device.

The electrochemical device includes a first electrode plate, a second electrode plate, and a separator disposed between the first electrode plate and the second electrode plate. The first electrode plate is electrically different from the second electrode plate.

In some embodiments, the first electrode plate includes a current collector, a tab and an active layer, the tab is electrically connected to and extends out of the current collector, and the active layer is disposed on the surface of the current collector.

In some embodiments, the active layer is disposed on a surface of one side of the current collector. In other embodiments, the active layer is disposed on surfaces of both sides of the current collector.

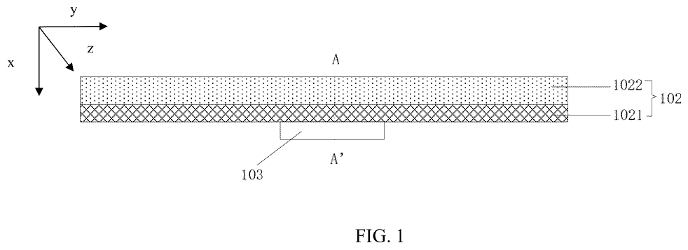

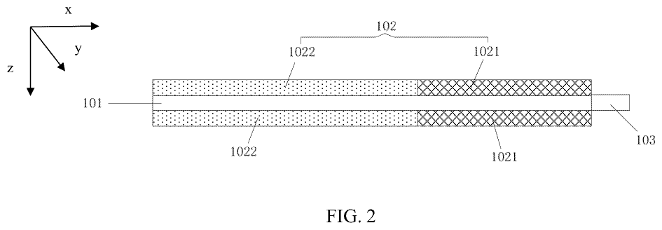

As shown in FIG. 1, a top view of the first electrode plate in an expanded state according to some embodiments is shown. As shown in FIG. 2, a cross-sectional view of the first electrode plate shown in FIG. 1 along the direction AA′ is shown. With reference to FIG. 1 and FIG. 2, the active layer 102 is disposed on the surfaces of both sides of the current collector 101, and the active layer 102 includes a first active layer 1021 and a second active layer 1022. As shown in FIG. 1, in a first direction x, the first active layer 1021 is located on a side of the second active layer 1022 facing the tab 103 (that is, in the first direction, the first active layer 1021 is closer to the side of the current collector where the tab extends out compared to the second active layer 1022), and is adjacent to or partially overlaps the second active layer 1022; and in a second direction y, the first active layer 1021 and the second active layer 1022 extend in a strip shape. As shown in FIG. 1, the first active layer 1021 and the second active layer 1022 are both in a rectangular strip shape and extend parallel to each other in the second direction y.

In this application, the above directions are defined as follows: In the three-dimensional rectangular coordinate system, the first direction x is the direction in which the tab extends out of the current collector, the third direction z is the thickness direction of the first electrode plate, and the second direction y is perpendicular to the plane on which the first direction x and the second direction y lie.

It should be understood that the above-mentioned “adjacent” refers to that the first active layer 1021 and the second active layer 1022 do not overlap in the third direction z (that is, the thickness direction of the electrode plate), and there is no spacing in the first direction x (that is, the direction in which the tab extends out of the current collector). In this way, the contact area of the first active layer 1021 and the second active layer 1022 can be prevented from being too thick, which affects the local thickness of the electrode plate and adversely affects the flatness of a battery cell. The above-mentioned “partially overlap” refers to that in the third direction z (that is, the thickness direction of the electrode plate), the projected areas of the first active layer 1021 and the second active layer 1022 on the current collector have an overlapping area, that is, on the surface of the current collector, in the contact area of the first active layer and the second active layer, the first active layer 1021 may be superimposed on the second active layer 1022, or the second active layer 1022 may be superimposed on the first active layer 1021.

Typically, in the coating process of electrode plate preparation, a metal foil is selected as the current collector, a surface of the metal foil is coated with an active slurry, there will be a coating area that is coated with the active slurry and an empty foil area that is not coated with the active slurry on the surface of the metal foil, and the empty foil area can be used to die-cut or weld the tab. In order to increase the energy density of the battery, before the above-mentioned coated foil is cut into electrode plates, the coating area needs to be compacted to increase the coating weight per unit area, that is, to increase the compaction density of the active material layer. At the edge of the coating area, that is, on a side of the coating area close to the empty foil area, the active material layer will be subject to the vertical stress of the compaction process and easily loosen, resulting in powder falling, and the occurrence of powder falling will lead to reduced coating weight per unit area at the edge of the electrode plate after cutting, thus reducing the energy density of the battery, and there is the risk of lithium precipitation.

In this application, in the coating process, the surface of the metal foil is coated with a first active slurry and a second active slurry which are two different slurries to form a first coating area coated with the first active slurry and a second coating area coated with the second active slurry, and the first coating area is located on a side of the second coating area close to the empty foil area, that is, the first active layer 1021 is provided on the edge of the second active layer 1022. By making a cohesive force of the first active layer 1021 greater than a cohesive force of the second active layer 1022, during the compaction process, the first active layer 1021 is not prone to loosening due to the greater cohesive force thereof, thereby reducing the phenomenon of powder falling at the edge.

Therefore, on the prepared electrode plate, the edge of the electrode plate has a coating weight per unit area equivalent to the middle part of the electrode plate, which is conducive to increasing the energy density of the electrochemical device. At the same time, since the possibility of powder falling at the edge is reduced, the compaction density of the electrode plate can be further increased, thereby increasing the volumetric energy density of the electrochemical device.

In some embodiments, the cohesive force of the first active layer is 10 N/m to 20 N/m and the cohesive force of the second active layer is 4 N/m to 8 N/m. If the cohesive force of the first active layer is too small, the effect on improving the powder falling at the edge of the first electrode plate is relatively limited; and if the cohesive force of the first active layer is too large, the compaction density of the active layer is usually required to be too large or more adhesive is used. If the compaction density is too large, it will easily affect the penetration of the electrolyte solution and affect the conductivity of the electrode plate; while using more adhesive means reducing the amount of active materials, which will affect the conductivity of the electrode plate and the energy density of the electrochemical device. In some embodiments, the cohesive force of the first active layer is 10 N/m, 12 N/m, 15 N/m, 18 N/m, 20 N/m or within the range of any two of the above values. In some embodiments, the cohesive force of the second active layer is 4 N/m, 6 N/m, 8 N/m, or within the range of any two of the above values.

In some embodiments, a width of the first active layer is 5 mm to 20 mm, and a width of the second active layer is 10 mm to 300 mm. If the width of the first active layer is too small, the effect on improving powder falling at the edge of the electrode plate is relatively limited; and if the width of the first active layer is too large, when the adhesive content in the first active layer is high, it will adversely affect the volumetric energy density of the electrochemical device. In some embodiments, the width of the first active layer is 5 mm, 12 mm, 15 mm, 18 mm, 20 mm, or within the range of any two of the above values. In some embodiments, the width of the second active layer is 10 mm, 30 mm, 50 mm, 80 mm, 100 mm, 120 mm, 150 mm, 180 mm, 300 mm or within the range of any two of the above values.

In some embodiments, a bonding force between the first active layer and the current collector is greater than a bonding force between the second active layer and the current collector. In this way, the first active layer is less likely to fall off from the current collector, and can more stably play the role of improving powder falling at the edge of the electrode plate.

In some embodiments, a bonding force between the first active layer and the current collector is 8 N/m to 20 N/m, and a bonding force between the second active layer and the current collector is 1 N/m to 8 N/m. If the bonding force between the first active layer and the current collector is too small, the first active layer will easily fall off from the current collector, which will affect the effect of the first active layer on improving the powder falling at the edge of the electrode plate; and if the bonding force between the first active layer and the current collector is too large, a high adhesive content in the first active layer is usually required, which is not conducive to increasing the volumetric energy density of the electrochemical device. In some embodiments, the bonding force between the first active layer and the current collector is 8 N/m, 10 N/m, 12 N/m, 15 N/m, 18 N/m, 20 N/m or within the range of any two of the above values. In some embodiments, the bonding force between the second active layer and the current collector is 1 N/m, 3 N/m, 5 N/m, 6 N/m, 8 N/m or within the range of any two of the above values.

In some embodiments, the first active layer includes a first active material and a first adhesive, the second active layer includes a second active material and a second adhesive, and the powder compaction density of the first active material is greater than the powder compaction density of the second active material. The greater powder compaction density indicates that the active material has a higher weight per unit volume using the same pressure. Therefore, during compacting, under the same cold pressing conditions, since the first active material located at the edge of the electrode plate has a higher powder compaction density, the edge of the electrode plate can accommodate more first active material without powder falling. Under this condition, the pressure during the compaction process can be increased. When the pressure increases, the powder may not fall off the edge of the electrode plate, thereby increasing the coating weight per unit area, and the compaction density of the electrode plate is increased, which is beneficial to increasing the energy density of the electrochemical device.

In some embodiments, the mass fraction of the first adhesive in the first active layer is greater than the mass fraction of the second adhesive in the second active layer. By making the mass fraction of the first adhesive in the first active layer greater than the mass fraction of the second adhesive in the second active layer, more adhesive may create a better adhesion between the active material particles, thereby making the cohesive force of the first active layer greater than the cohesive force of the second active layer.

In some embodiments, a powder compaction density of the first active material is 1.8 g/cm³ to 2.5 g/cm³, and a powder compaction density of the second active material is 1 g/cm³ to 1.7 g/cm³. By making the powder compaction density of the first active material greater than 1.8 g/cm³, the phenomenon of powder falling at the edge of the electrode plate can be improved; however, when the powder compaction density of the first active material is too high, for example, greater than 2.5 g/cm³, it may not be conducive to the infiltration of the electrolyte solution. In some embodiments, the powder compaction density of the first active material is 1.8 g/cm³, 2.0 g/cm³, 2.2 g/cm³, 2.5 g/cm³ or within the range of any two of the above values. In some embodiments, the powder compaction density of the second active material is 1 g/cm³, 1.2 g/cm³, 1.5 g/cm³, 1.7 g/cm³ or within the range of any two of the above values.

In some embodiments, the mass fraction of the first adhesive in the first active layer is 15% to 30%, and the mass fraction of the second adhesive in the second active layer is 1% to 10%. If the mass fraction of the first adhesive in the first active layer is too small, it is not conducive to increasing the cohesive force of the first active layer, and the effect of improving the powder falling at the edge of the electrode plate is relatively limited; and if the mass fraction of the first adhesive in the first active layer is too large, it will be not conducive to the increase of the volumetric energy density of the electrochemical device. In some embodiments, the mass fraction of the first adhesive in the first active layer is 15%, 20%, 25%, 30% or within the range of any two of the above values. In some embodiments, the mass fraction of the second adhesive in the second active layer is 1%, 3%, 5%, 8%, 10% or within the range of any two of the above values.

In some embodiments, the first electrode plate is a negative electrode plate, the active layer is a negative active layer, the current collector is negative current collector, and the negative current collector can be at least one of copper foil, copper alloy foil, nickel foil, stainless steel foil, titanium foil, nickel foam, copper foam, composite current collector or carbon-based current collector.

Correspondingly, the second electrode plate is a positive electrode plate. By improving the phenomenon of powder falling at the edge of the negative electrode plate, the coating weight per unit area of the negative active material at the edge of the electrode plate can be increased, which provides more locations for the intercalation and deintercalation of lithium ions, thereby reducing the risk of lithium precipitation at the edge of the negative electrode plate and conducive to increasing the energy density of the electrochemical device.

In some embodiments, the first active material and the second active material each independently include at least one of natural graphite, artificial graphite, mesophase microcarbon sphere, hard carbon, soft carbon, silicon, silicon-carbon composite, silicon oxide (such as SiOₓ (0<x<2)), Li—Sn alloy, Li—Sn—O alloy, Sn, SnO, SnO₂, lithium titanate, Li—Al alloy or metallic lithium.

In some embodiments, the first electrode plate is a positive electrode plate, the active layer is a positive active layer, the current collector is a positive current collector, and the positive current collector includes aluminum foil.

Correspondingly, the second electrode plate is a negative electrode plate. By improving the phenomenon of powder falling at the edge of the positive electrode plate, the coating weight per unit area of the positive active material at the edge of the electrode plate can be increased, thereby increasing the number of lithium ions, which is conducive to increasing the energy density of the electrochemical device.

In some embodiments, the first active material and the second active material each independently include at least one of lithium cobalt oxide, lithium iron phosphate, lithium iron manganese phosphate, sodium iron phosphate, lithium vanadium phosphate, sodium vanadium phosphate, lithium vanadyl phosphate, sodium vanadyl phosphate, lithium vanadate, lithium manganate, lithium nickelate, lithium nickel cobalt manganese, lithium-rich manganese-based materials or lithium nickel cobalt aluminate.

In some embodiments, the first adhesive and the second adhesive each independently include at least one of polypropylene alcohol, polyacrylic acid, polyacrylate, polyimide, polyamide-imide, styrene-butadiene rubber, polyvinylidene fluoride, polyvinylidene difluoride, polytetrafluoroethylene, polyvinyl butyral, water-based acrylic resin or carboxymethyl cellulose salt.

In some embodiments, the first active layer and the second active layer each further include a conductive agent. In some embodiments, the conductive agent includes at least one of conductive carbon black, Ketjen black, flake graphite, graphene, carbon nanotubes or carbon fibers.

In some embodiments, the tab and the current collector 101 are integrally formed. In this way, it is beneficial to simplifying the preparation process of the electrochemical device, and is also beneficial to the stable connection of the tab.

In some embodiments, the electrochemical device may further include an electrolyte, which may be at least one of a gel electrolyte, a solid electrolyte, and an electrolyte solution. In some embodiments, the electrolyte solution includes a lithium salt and a non-aqueous solvent. In some embodiments, the lithium salt may include at least one of LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiSiF₆, LiBOB or lithium difluoroborate, etc. The non-aqueous solvent may be at least one of a carbonate compound, a carboxylate compound, an ether compound, or other organic solvents etc.

In some embodiments, the separator includes at least one of polyethylene, polypropylene, polyvinylidene fluoride, polyethylene terephthalate, polyimide, or aramid. For example, polyethylene includes at least one selected from high density polyethylene, low density polyethylene or ultra high molecular weight polyethylene. Particularly, polyethylene and polypropylene have a good effect for preventing short circuits and can improve the stability of a battery through a shutdown effect.

In some embodiments, a surface of the separator may also include a porous layer, and the porous layer is disposed on at least one surface of the separator. The porous layer includes inorganic particles and an adhesive. The inorganic particles are selected from at least one of aluminum oxide (Al₂O₃), silicon oxide (SiO₂), magnesium oxide (MgO), titanium oxide (TiO₂), hafnium dioxide (HfO₂), tin oxide (SnO₂), ceria (CeO₂), nickel oxide (NiO), zinc oxide (ZnO), calcium oxide (CaO), zirconium oxide (ZrO₂), yttrium oxide (Y₂O₃), silicon carbide (SiC), boehmite, aluminum hydroxide, magnesium hydroxide, calcium hydroxide or barium sulfate. The porous layer on the surface of the separator can improve the heat resistance, oxidation resistance and electrolyte wetting property of the separator and enhance the adhesion force between the separator and an electrode plate.

In some embodiments of this application, the electrochemical device is prepared by laminating a first electrode plate, a separator and a second electrode plate and then rolling same to obtain a winding type electrode assembly. In some embodiments, the electrochemical device is prepared by stacking the first electrode plate, the separator and the second electrode plate to obtain a stacked type electrode assembly.

In some embodiments, the electrochemical device includes a lithium-ion battery, but this application is not limited thereto.

In some embodiments of this application, taking lithium-ion batteries as an example, the positive electrode plate, the separator, and the negative electrode plate are prepared into a winding type electrode assembly, and then packed into, for example, an aluminum-plastic film for encapsulation, the electrolyte solution is injected, and formation and encapsulation are performed to form a lithium-ion battery. The performance of the prepared lithium-ion battery is then tested.

It will be appreciated by those skilled in the art that the preparation method of the electrochemical device (e.g., the lithium-ion battery) described above is merely an example. Other methods commonly used in the art may be employed without departing from the disclosure herein.

Embodiments of this application further provide an electronic device. The electronic device includes the electrochemical device described above. The electronic device of the embodiment of this application is not particularly limited, and may be used for any electronic device known in the art. In some embodiments, electronic devices may include, but are not limited to, laptop computers, pen computers, mobile computers, e-book players, portable telephones, portable fax machines, portable copiers, portable printers, stereo headsets, video recorders, LCD TVs, portable cleaners, portable CD players, mini discs, transceivers, electronic notepads, calculators, memory cards, portable recorders, radios, backup power supplies, motors, cars, motorcycles, power-assisted bicycles, bicycles, drones, lighting fixtures, toys, game consoles, clocks, power tools, flashlights, cameras, large household batteries and lithium-ion capacitors, etc.

Some specific embodiments and comparative embodiments are listed below to better illustrate this application, wherein the lithium-ion battery is used as an example.

### Embodiment 1

Preparation of positive electrode plate: Mix the positive active materials lithium cobalt oxide, conductive carbon black (Super P), and polyvinylidene difluoride (PVDF) in a weight ratio of 97:1.4:1.6, add N-methylpyrrolidone (NMP) as the solvent, and stir evenly. Coat the positive current collector aluminum foil with the slurry (solid content: 72 wt %) evenly with a coating thickness of 80 μm, dry at 85° C., perform cold pressing, cutting into pieces and slitting, and then dry under a vacuum condition at 85° C. for 4 hours to obtain the positive electrode plate.

Preparation of negative electrode plate: Stir the negative active materials natural graphite, dispersant lithium carboxymethyl cellulose, and adhesive polyacrylic acid in a weight ratio of 8:0.2:1.8 with water until the slurry is evenly dispersed to obtain a first slurry. Stir the negative active materials natural graphite, dispersant lithium carboxymethyl cellulose, and adhesive polyacrylic acid in a weight ratio of 9:0.2:0.8 with water until the slurry is evenly dispersed to obtain a second slurry. Use a copper foil being 10 μm thick as the negative current collector, and respectively coat a surface of the negative current collector with the first slurry and the second slurry by using the zebra coating process (that is, interval coating) to form a coating area, where the empty foil area not coated with the first slurry and the second slurry is exposed, the first slurry is located on a side of the second slurry close to the empty foil area, that is, the second slurry is located at the edge of the coating area, and the coating thickness is 50 μm; and dry at 85° C., perform cold pressing, cutting into pieces and slitting, die-cut the tabs in the empty foil area, and further dry under a vacuum condition at 120° C. for 12 hours to obtain the negative electrode tab.

Preparation of separator: The separator is polyethylene (PE) being 7 μm thick.

Preparation of electrolyte solution: In a dry argon atmosphere glove box, mix ethylene carbonate (EC), propylene carbonate (PC), and diethyl carbonate (DEC) according to a mass ratio of EC:PC:DEC=1:1:1, dissolve, stir thoroughly, then add lithium salt LiPF₆, and mixed evenly to obtain the electrolyte solution, where the concentration of LiPF₆ is 1 mol/L.

Preparation of lithium-ion battery: Stack the positive electrode plate, the separator, and the negative electrode plate in order so that the separator is located between the positive electrode plate and the negative electrode plate to play an isolation role, and wind to obtain an electrode assembly. Place the electrode assembly in an outer packaging aluminum-plastic film, inject the electrolyte solution after the moisture is removed at 80° C., perform encapsulation, and perform a process flow of formation, degassing and edge cutting to obtain the lithium-ion battery.

In other embodiments and comparative embodiments, parameters are changed based on the steps of Embodiment 1. The specific parameters changed are as follows.

Embodiment 2 differs from Embodiment 1 only in the composition of the first slurry, which is: the weight ratio of natural graphite to dispersant lithium carboxymethyl cellulose, and adhesive polyacrylic acid is 7.8:0.2:2.

Embodiment 3 differs from Embodiment 1 only in the composition of the first slurry: the weight ratio of natural graphite to dispersant lithium carboxymethyl cellulose, and adhesive polyacrylic acid is 7.6:0.2:2.2.

Embodiment 4 differs from Embodiment 1 only in that the dispersant in the second slurry is sodium carboxymethyl cellulose and the adhesive is styrene-butadiene rubber; in addition, the composition of the first slurry is different, as follows: the weight ratio of artificial graphite to dispersant sodium carboxymethyl cellulose, and adhesive styrene-butadiene rubber is 9:0.2:0.8, and the powder compaction density of artificial graphite is 1.85 g/cm³.

Embodiment 5 differs from Embodiment 4 only in that the powder compaction density of artificial graphite is 1.95 g/cm³.

Embodiment 6 differs from Embodiment 4 only in that the powder compaction density of artificial graphite is 2 g/cm³.

Embodiment 7 differs from Embodiment 1 only in the composition of the first slurry, which is: the weight ratio of artificial graphite to dispersant sodium carboxymethyl cellulose, and adhesive styrene-butadiene rubber is 8:0.2:1.8, and the powder compaction density of artificial graphite is 1.85 g/cm³.

Embodiment 8 differs from Embodiment 7 only in that the powder compaction density of artificial graphite is 2 g/cm³.

In Comparative Embodiment 1, the negative current collector is only coated with the second slurry, but not coated with the first slurry, so that the composition of the second slurry is: the weight ratio of natural graphite to dispersant sodium carboxymethyl cellulose, and adhesive styrene-butadiene rubber is 9:0.2:0.8, and the powder compaction density of artificial graphite is 1.65 g/cm³.

Comparative Embodiment 2 differs from Comparative Embodiment 1 only in that the active material of the second slurry is changed from natural graphite to hard carbon, and the powder compaction density of hard carbon is 1.2 g/cm³. Comparative Embodiment 3 differs from Comparative Embodiment 1 only in that the adhesive in the second slurry is changed from styrene-butadiene rubber to sodium polyacrylate.

The test methods for the parameters of this application are described below.

1. Test for bonding force between negative active layer and negative current collector:

The brand of the instrument used to test the bonding force between the negative active layer and the negative current collector is Instron, and the model is 33652. The negative electrode (width 30 mm×length (100 mm to 160 mm)) is taken, and fixed on a steel plate with double-sided tape (model: 3M9448A, width 20 mm×length (90 mm to 150 mm)). The paper tape with the same width as the negative electrode is fixed to one side of the negative electrode with an adhesive tape, the limit block of the tensile machine is adjusted to the appropriate position, the paper tape is folded upward and slipped by 40 mm, the slip rate is 50 mm/min, and the bonding force between the negative active layer and the negative current collector is tested at 1800 (that is, stretched in the opposite direction).

2. Test method for cohesive force:

The dried electrode plate is taken, and cut with a blade to obtain a sample of width 30 mm×length (100 mm to 160 mm). A special double-sided tape is attached to the steel plate. The tape is width 20 mm×length (90 mm to 150 mm). The electrode plate sample is attached to the double-sided tape with the test side facing down. Then the green glue (width 20 mm×length (90 mm to 150 mm) is attached tightly to the surface of the electrode plate. A paper tape with the same width as the electrode plate and a length 80 mm to 200 mm longer than the sample length is inserted under the green glue, and fixed with wrinkle glue. The power of the Suns tensile machine is turned on, the indicator light is on, the limit block is adjusted to the appropriate position, the green glue is folded upward and slipped by 40 mm, the slip rate is 50 mm/min, and the cohesive force between the negative active layers is tested at 1800 (that is, stretched in the opposite direction).

3. Test for powder compaction density

Powder is scraped from the electrode plate and sintered to obtain the active material powder, which is placed in the powder density tester mold (test mold (CARVER #3619 (13 mm))). The testing equipment is Suns UTM7305, and the mold is placed in the middle of the upper and lower pressure plates of the equipment, and by clicking the run button in the device, the device will run according to the set parameters. When the pressure is relieved from the device pressure point to 5T, the displacement value at this time is recorded. This is the thickness of the sample under this pressure (the pressure increase rate is 10 mm/min, the pressure increase holding time is 30 s, the pressure relief rate is 30 mm/min, and the pressure relief holding time is 10 s). The powder compaction density can be calculated by the following formula:

ρc=m/V=m/S*H,

where pc denotes the powder compaction density, with a unit of g/cm³;

m denotes the mass of the weighed material, with a unit of g;

S denotes the bottom area of the mold, with a unit of cm²; and

H denotes the height after compaction, with a unit of cm.

4. Test method for adhesive content

Powder is scraped from the electrode plate and put into the thermogravimetric tester, the temperature range is set to 20˜500° C., the temperature rise rate is 5° C./min, the gas atmosphere is air, and then the weight decreases when the operating temperature of the equipment is 200-400° C. The weight percentage of the reduced weight is the adhesive content.

Table 1A and Table 1B show various parameters and evaluation results of corresponding Embodiments 1 to 8 and Comparative Embodiments 1 to 3.

TABLE 1A

| | First active layer | | | | | |
|---|---|---|---|---|---|---|
| | | Active | | | | |
| | | material | | | | |
| | | powder | | | | |
| | | compaction | | | Cohesive | Bonding |
| | Raw material | density | Width | Thickness | force | force |
| Embodiment | ratio | (g/cm³) | (mm) | (mm) | (N/m) | (N/m) |
| 1 | 80% natural | 1.65 | 10 | 0.12 | 10 | 8 |
| | graphite + 2% | | | | | |
| | lithium | | | | | |
| | carboxymethyl | | | | | |
| | cellulose + 18% | | | | | |
| | polyacrylic acid | | | | | |
| 2 | 78% natural | 1.65 | 10 | 0.12 | 13 | 10 |
| | graphite + 2% | | | | | |
| | lithium | | | | | |
| | carboxymethyl | | | | | |
| | cellulose + 20% | | | | | |
| | polyacrylic acid | | | | | |
| 3 | 76% natural | 1.65 | 10 | 0.12 | 14 | 11 |
| | graphite + 2% | | | | | |
| | lithium | | | | | |
| | carboxymethyl | | | | | |
| | cellulose + 22% | | | | | |
| | polyacrylic acid | | | | | |
| 4 | 90% artificial | 1.85 | 10 | 0.12 | 9 | 7 |
| | graphite + 2% | | | | | |
| | sodium | | | | | |
| | carboxymethyl | | | | | |
| | cellulose + 8% | | | | | |
| | styrene-butadiene | | | | | |
| | rubber | | | | | |
| 5 | 90% artificial | 1.95 | 10 | 0.12 | 10 | 8 |
| | graphite + 2% | | | | | |
| | sodium | | | | | |
| | carboxymethyl | | | | | |
| | cellulose + 8% | | | | | |
| | styrene-butadiene | | | | | |
| | rubber | | | | | |
| 6 | 90% artificial | 2 | 10 | 0.12 | 11 | 10 |
| | graphite + 2% | | | | | |
| | sodium | | | | | |
| | carboxymethyl | | | | | |
| | cellulose + 8% | | | | | |
| | styrene-butadiene | | | | | |
| | rubber | | | | | |
| 7 | 80% artificial | 1.85 | 10 | 0.12 | 15 | 13 |
| | graphite + 2% | | | | | |
| | sodium | | | | | |
| | carboxymethyl | | | | | |
| | cellulose + 18% | | | | | |
| | styrene-butadiene | | | | | |
| | rubber | | | | | |
| 8 | 80% artificial | 2 | 10 | 0.12 | 17 | 15 |
| | graphite + 2% | | | | | |
| | sodium | | | | | |
| | carboxymethyl | | | | | |
| | cellulose + 18% | | | | | |
| | styrene-butadiene | | | | | |
| | rubber | | | | | |
| 1 | / | / | / | / | / | / |
| 2 | / | / | / | / | / | / |
| 3 | / | / | / | / | / | / |

TABLE 1B

| | Second active layer | | | | | | |
|---|---|---|---|---|---|---|---|
| | | Active | | | | | |
| | | material | | | | | |
| | | powder | | | | | Powder |
| | | compaction | | | Cohesive | Bonding | falling |
| | Raw material | density | Width | Thickness | force | force | at the |
| Embodiment | ratio | (g/cm³) | (mm) | (mm) | (N/m) | (N/m) | edge |
| 1 | 90% natural | 1.65 | 300 | 0.12 | 6 | 3.5 | ++++ |
| | graphite + 2% | | | | | | |
| | lithium | | | | | | |
| | carboxymethyl | | | | | | |
| | cellulose + 8% | | | | | | |
| | polyacrylic acid | | | | | | |
| 2 | 90% natural | 1.65 | 300 | 0.12 | 6 | 3.5 | ++++ |
| | graphite + 2% | | | | | | |
| | lithium | | | | | | |
| | carboxymethyl | | | | | | |
| | cellulose + 8% | | | | | | |
| | polyacrylic acid | | | | | | |
| 3 | 90% natural | 1.65 | 300 | 0.12 | 6 | 3.5 | ++++ |
| | graphite + 2% | | | | | | |
| | lithium | | | | | | |
| | carboxymethyl | | | | | | |
| | cellulose + 8% | | | | | | |
| | polyacrylic acid | | | | | | |
| 4 | 90% natural | 1.65 | 300 | 0.12 | 5 | 3.5 | ++++ |
| | graphite + 2% | | | | | | |
| | sodium | | | | | | |
| | carboxymethyl | | | | | | |
| | cellulose + 8% | | | | | | |
| | styrene- | | | | | | |
| | butadiene | | | | | | |
| | rubber | | | | | | |
| 5 | 90% natural | 1.65 | 300 | 0.12 | 5 | 3.5 | ++++ |
| | graphite + 2% | | | | | | |
| | sodium | | | | | | |
| | carboxymethyl | | | | | | |
| | cellulose + 8% | | | | | | |
| | styrene- | | | | | | |
| | butadiene | | | | | | |
| | rubber | | | | | | |
| 6 | 90% natural | 1.65 | 300 | 0.12 | 5 | 3.5 | ++++ |
| | graphite + 2% | | | | | | |
| | sodium | | | | | | |
| | carboxymethyl | | | | | | |
| | cellulose + 8% | | | | | | |
| | styrene- | | | | | | |
| | butadiene | | | | | | |
| | rubber | | | | | | |
| 7 | 90% natural | 1.65 | 300 | 0.12 | 6 | 3.5 | +++++ |
| | graphite + 2% | | | | | | |
| | lithium | | | | | | |
| | carboxymethyl | | | | | | |
| | cellulose + 8% | | | | | | |
| | polyacrylic acid | | | | | | |
| 8 | 90% natural | 1.65 | 300 | 0.12 | 6 | 3.5 | +++++ |
| | graphite + 2% | | | | | | |
| | lithium | | | | | | |
| | carboxymethyl | | | | | | |
| | cellulose + 8% | | | | | | |
| | polyacrylic acid | | | | | | |
| 1 | 90% natural | 1.65 | / | 0.12 | 5 | 3.5 | +++ |
| | graphite + 2% | | | | | | |
| | sodium | | | | | | |
| | carboxymethyl | | | | | | |
| | cellulose + 8% | | | | | | |
| | styrene- | | | | | | |
| | butadiene | | | | | | |
| | rubber | | | | | | |
| 2 | 90% hard | 1.2 | / | 0.12 | 3 | 2.5 | +++ |
| | carbon + 2% | | | | | | |
| | sodium | | | | | | |
| | carboxymethyl | | | | | | |
| | cellulose + 8% | | | | | | |
| | styrene- | | | | | | |
| | butadiene | | | | | | |
| | rubber | | | | | | |
| 3 | 90% natural | 1.65 | / | 0.12 | 4.5 | 3 | +++ |
| | graphite + 2% | | | | | | |
| | sodium | | | | | | |
| | carboxymethyl | | | | | | |
| | cellulose + 8% | | | | | | |
| | sodium | | | | | | |
| | polyacrylate | | | | | | |

Note:
“/” means no addition; “+++++” means no powder falling, that is, there is no powder falling at the edge of the electrode plate or the amount of powder falling is very small and can be ignored, and the cut surface of the active material layer at the edge of the electrode plate is neat; “++++” means almost no powder falling or slight powder falling, that is, although there is powder falling, the amount of powder falling is small, there is powder falling in individual areas of the cut surface of the active material layer at the edge of the electrode plate, but overall the cut surface remains basically neat; “+++” means that there is powder falling, but the powder falling is obvious, and there is powder falling in many local areas of the cut surface of the active material layer at the edge of the electrode plate.

By comparing Embodiment 4 and Comparative Embodiment 1, it can be seen that compared with the negative electrode plate including only the second active layer, by providing the additional first active layer and making the cohesive force of the first active layer greater than the cohesive force of the second active layer, powder falling at the edge of the negative electrode plate can be significantly improved.

By comparing Embodiments 1 to 3, it can be seen that when the active materials in the first active layer are the same, as the amount of adhesive in the first active layer increases, the cohesive force and the bonding force of the first active layer become greater, and the negative electrode plate almost has no powder falling.

By comparing Embodiments 4 to 6, it can be seen that when the content of each component in the first active layer is the same, the greater the powder compaction density of the first active material in the first active layer, the greater the cohesive force and the bonding force, and the negative electrode plate almost has no powder falling.

By comparing Embodiments 1 to 6 and Embodiments 7 to 8, it can be seen that the greater the powder compaction density of the first active material in the first active layer, the greater the amount of adhesive, the greater the cohesive force and the bonding force, and in this case, the negative electrode plate does not have powder falling.

In Comparative Embodiments 1 to 3, when the same active layer is provided in the middle and at the edge of the current collector, obvious powder falling occurs. In Comparative Embodiment 2, compared to Comparative Embodiment 1, when the type of active material of the first active layer and the powder compaction density are changed, obvious powder falling still occurs. In Comparative Embodiment 3, compared to Comparative Embodiment 1, when the adhesive in the first active layer is changed, obvious powder falling also still occurs. Thus, it can be seen that when the powder compaction density of the first active material is low, the amount of adhesive in the first active material is small, and powder will easily fall at the edge of the electrode plate.

The above description is only a preferred embodiment of this application and is illustrative of the principles of the technology employed. It will be understood by those skilled in the art that the scope of the disclosure referred to in this application is not limited to technical solutions resulting from any particular combination of the features described above, but is intended to encompass other technical solutions resulting from any combination of the technical features described above or their equivalents, for example, a technical solution formed by replacing the above-mentioned features with the technical features with similar functions disclosed in this application.

What is claimed is:

1. An electrochemical device, comprising a first electrode plate, a second electrode plate of different polarity from the first electrode plate, and a separator disposed between the first electrode plate and the second electrode plate; wherein the first electrode plate comprising:
a current collector;
a tab, electrically connected to and extending out of the current collector; and
an active layer, provided on a surface of the current collector, the active layer comprising a first active layer and a second active layer; in a first direction, the first active layer being located on a side of the second active layer facing the tab, and being adjacent to or partially overlapping the second active layer; and in a second direction, the first active layer and the second active layer extending in a strip shape, wherein a cohesive force of the first active layer is greater than a cohesive force of the second active layer;
in a three-dimensional rectangular coordinate system, the first direction is a direction in which the tab extends out of the current collector, a third direction is a thickness direction of a negative electrode plate, and the second direction is perpendicular to a plane on which the first direction and the second direction lie.

2. The electrochemical device according to claim 1, wherein the cohesive force of the first active layer is 10 N/m to 20 N/m, and the cohesive force of the second active layer is 4 N/m to 8 N/m.

3. The electrochemical device according to claim 1, wherein a width of the first active layer is 5 mm to 20 mm, and a width of the second active layer is 10 mm to 300 mm.

4. The electrochemical device according to claim 1, wherein a bonding force between the first active layer and the current collector is greater than a bonding force between the second active layer and the current collector.

5. The electrochemical device according to claim 1, wherein a bonding force between the first active layer and the current collector is 8 N/m to 20 N/m, and a bonding force between the second active layer and the current collector is 1 N/m to 8 N/m.

6. The electrochemical device according to claim 1, wherein the first active layer comprises a first active material and a first adhesive, the second active layer comprises a second active material and a second adhesive; a powder compaction density of the first active material is greater than a powder compaction density of the second active material, and/or a mass fraction of the first adhesive in the first active layer is greater than a mass fraction of the second adhesive in the second active layer.

7. The electrochemical device according to claim 6, wherein the powder compaction density of the first active material is 1.8 g/cm³ to 2.5 g/cm³, and the powder compaction density of the second active material is 1 g/cm³ to 1.7 g/cm³;
and/or the mass fraction of the first adhesive in the first active material layer is 15% to 30%, and the mass fraction of the second adhesive in the second active material layer is 1% to 10%.

8. The electrochemical device according to claim 6, wherein the first active material and the second active material each independently comprises at least one of natural graphite, artificial graphite, mesophase microcarbon sphere, hard carbon, soft carbon, silicon, silicon-carbon composite, silicon oxide, Li—Sn alloy, Li—Sn—O alloy, Sn, SnO, SnO₂, lithium titanate, Li—Al alloy or metallic lithium; the first adhesive and the second adhesive each independently comprises at least one of polypropylene alcohol, polyacrylic acid, polyacrylate, polyimide, polyamide-imide, styrene-butadiene rubber, polyvinylidene fluoride, polyvinylidene difluoride, polytetrafluoroethylene, polyvinyl butyral, water-based acrylic resin or carboxymethyl cellulose salt.

9. The electrochemical device according to claim 1, wherein the tab and the current collector are integrally formed.

10. The electrochemical device according to claim 1, wherein the first electrode plate is a positive electrode plate, the first active material and the second active material each independently comprises at least one of lithium cobalt oxide, lithium iron phosphate, lithium iron manganese phosphate, sodium iron phosphate, lithium vanadium phosphate, sodium vanadium phosphate, lithium vanadyl phosphate, sodium vanadyl phosphate, lithium vanadate, lithium manganate, lithium nickelate, lithium nickel cobalt manganese, lithium-rich manganese-based materials or lithium nickel cobalt aluminate.

11. An electronic device, comprising the electrochemical device according to claim 1.

12. The electronic device according to claim 11, wherein the cohesive force of the first active layer is 10 N/m to 20 N/m, and the cohesive force of the second active layer is 4 N/m to 8 N/m.

13. The electronic device according to claim 11, wherein a width of the first active layer is 5 mm to 20 mm, and a width of the second active layer is 10 mm to 300 mm.

14. The electronic device according to claim 11, wherein a bonding force between the first active layer and the current collector is greater than a bonding force between the second active layer and the current collector.

15. The electronic device according to claim 11, wherein a bonding force between the first active layer and the current collector is 8 N/m to 20 N/m, and a bonding force between the second active layer and the current collector is 1 N/m to 8 N/m.

16. The electronic device according to claim 11, wherein the first active layer comprises a first active material and a first adhesive, the second active layer comprises a second active material and a second adhesive, a powder compaction density of the first active material is greater than a powder compaction density of the second active material, and/or a mass fraction of the first adhesive in the first active layer is greater than a mass fraction of the second adhesive in the second active layer.

17. The electronic device according to claim 16, wherein the powder compaction density of the first active material is 1.8 g/cm³ to 2.5 g/cm³, and the powder compaction density of the second active material is 1 g/cm³ to 1.7 g/cm³; and/or the mass fraction of the first adhesive in the first active material layer is 15% to 30%, and the mass fraction of the second adhesive in the second active material layer is 1% to 10%.

18. The electronic device according to claim 16, wherein the first active material and the second active material each independently comprises at least one of natural graphite, artificial graphite, mesophase microcarbon sphere, hard carbon, soft carbon, silicon, silicon-carbon composite, silicon oxide, Li—Sn alloy, Li—Sn—O alloy, Sn, SnO, SnO₂, lithium titanate, Li—Al alloy or metallic lithium; the first adhesive and the second adhesive each independently comprises at least one of polypropylene alcohol, polyacrylic acid, polyacrylate, polyimide, polyamide-imide, styrene-butadiene rubber, polyvinylidene fluoride, polyvinylidene difluoride, polytetrafluoroethylene, polyvinyl butyral, water-based acrylic resin or carboxymethyl cellulose salt.

19. The electronic device according to claim 11, wherein the tab and the current collector are integrally formed.

20. The electronic device according to claim 11, wherein the first electrode plate is a positive electrode plate, the first active material and the second active material each independently comprises at least one of lithium cobalt oxide, lithium iron phosphate, lithium iron manganese phosphate, sodium iron phosphate, lithium vanadium phosphate, sodium vanadium phosphate, lithium vanadyl phosphate, sodium vanadyl phosphate, lithium vanadate, lithium manganate, lithium nickelate, lithium nickel cobalt manganese, lithium-rich manganese-based materials or lithium nickel cobalt aluminate.
